(19) United States
(12) Patent Application Publication
(10) Pub. No.: US 2024/0040305 A1
(43) Pub. Date: Feb. 1, 2024

(54) VEHICLE AND CONTROL SYSTEM

(71) Applicant: SUBARU CORPORATION, Tokyo (JP)

(72) Inventors: Kazuhiro HAYAKAWA, Tokyo (JP); Junichi MOTOYAMA, Tokyo (JP); Takuya HOMMA, Tokyo (JP); Ryota NAKAMURA, Tokyo (JP); Tsukasa MIKUNI, Tokyo (JP); Yuta GOTO, Tokyo (JP); Takuya KANETA, Tokyo (JP)

(21) Appl. No.: 18/350,136

(22) Filed: Jul. 11, 2023

(30) Foreign Application Priority Data
Jul. 29, 2022 (JP) 2022-121292

(51) Int. Cl. H04R 3/00; B60R 16/037

(52) U.S. Cl. CPC H04R 3/00; B60R 16/0373; H04R 2499/13

(57) ABSTRACT

A vehicle includes an information collector, a detector, a setting unit, an accelerator position detector, and a control processor. The information collector collects information regarding an occupant of the vehicle to be used for determining a mood of the occupant. The detector detects the mood of the occupant based on the information. The setting unit performs setting of a sound quality parameter of a traveling sound to be outputted to an interior of a vehicle compartment of the vehicle based on the mood of the occupant. The accelerator position detector detects an accelerator position of the vehicle. The control processor generates the traveling sound based on the sound quality parameter and the accelerator position, and outputs the traveling sound to the interior of the vehicle compartment of the vehicle.

### CROSS-REFERENCE TO RELATED APPLICATIONS

The present application claims priority from Japanese Patent Application No. 2022-121292 filed on Jul. 29, 2022, the entire contents of which are hereby incorporated by reference.

### BACKGROUND

The disclosure relates to a vehicle and a control system. In recent years, a vehicle has been put into practical use which generates traveling sounds such as engine sounds, intake sounds, or exhaust sounds in accordance with a traveling state such as the number of revolutions of an engine of the vehicle, and outputs the traveling sounds to inside the vehicle.

According to an example of such a technique, the traveling sounds are changed in accordance with accelerator operations performed by a driver who drives the vehicle. Reference is made to Japanese Unexamined Patent Application Publication No. 2017-181921, for example.

### SUMMARY

An aspect of the disclosure provides a vehicle including an information collector, a detector, a setting unit, an accelerator position detector, and a control processor. The information collector is configured to collect information regarding an occupant of the vehicle to be used for determining a mood of the occupant. The detector is configured to detect the mood of the occupant based on the information. The setting unit is configured to perform setting of one or more sound quality parameters of a traveling sound to be outputted to an interior of a vehicle compartment of the vehicle based on the mood of the occupant. The accelerator position detector is configured to detect an accelerator position of the vehicle. The control processor is configured to generate the traveling sound based on the one or more sound quality parameters and the accelerator position and output the traveling sound to the interior of the vehicle compartment of the vehicle.

An aspect of the disclosure provides a control system including a vehicle and a server communicably coupled to the vehicle. The vehicle includes an information collector, a setting unit, an accelerator position detector, and a control processor. The information collector is configured to collect information an occupant of the vehicle to be used for determining a mood of the occupant and send the information to the server. The setting unit is configured to perform setting of one or more sound quality parameters of a traveling sound to be outputted to an interior of a vehicle compartment of the vehicle based on a mood of the occupant detected by the server. The accelerator position detector is configured to detect an accelerator position of the vehicle. The control processor is configured to generate the traveling sound based on the one or more sound quality parameters and the accelerator position and output the traveling sound to the interior of the vehicle compartment of the vehicle. The server includes a detector and a transmitter. The detector is configured to perform a determination as to the mood of the occupant of the vehicle based on the information regarding the moods of the occupant of the vehicle received from the vehicle. The transmitter is configured to send a result of determination to the vehicle.

An aspect of the disclosure provides a vehicle including a sensor or a communication interface, an accelerator position sensor, a sound speaker, and circuitry. The sensor or the communication interface is configured to collect first information to be used for determining a mood of an occupant of the vehicle. The accelerator position sensor is configured to detect an accelerator position of the vehicle. The sound speaker is configured to output a traveling sound to an interior of a vehicle compartment of the vehicle. The circuitry is configured to process the first information collected by the sensor or the communication interface and data on the accelerator position detected by the accelerator position sensor. The circuitry is further configured to detect the mood of the occupant based on the first information collected by the sensor or the communication interface, set one or more sound quality parameters of the traveling sound to be outputted to the interior of the vehicle compartment of the vehicle based on the mood of the occupant, generate the traveling sound based on the one or more sound quality parameter and the accelerator position, and output the traveling sound to the sound speaker.

An aspect of the disclosure provides a control system including a vehicle and a server communicably coupled to the vehicle. The vehicle includes a sensor or a first communication interface, a second communication interface, an acceleration position sensor, a sound speaker, and first circuitry. The sensor or the first communication interface is configured to collect first information to be used for determining a mood of an occupant of the vehicle. The second communication interface is configured to send the first information collected by the sensor or the first communication interface to the server. The accelerator position sensor is configured to detect an accelerator position of the vehicle. The sound speaker is configured to output a traveling sound to an interior of a vehicle compartment of the vehicle. The first circuitry is configured to process second information acquired from the server as a response to the first information sent from the second communication interface to the server and data on the accelerator position detected by the accelerator position sensor. The first circuitry is further configured to set one or more sound quality parameters of the traveling sound to be outputted to the interior of the vehicle compartment of the vehicle based on the second information acquired from the server, generate the traveling sound based on the one or more sound quality parameters and the accelerator position, and output the traveling sound to the sound speaker. The server includes second circuitry and a third communication interface. The second circuitry is configured to perform a determination as to the mood of the occupant of the vehicle based on the first information received from the vehicle. The third communication interface is configured to receive the first information from the vehicle and send a result of the determination as the second information to the vehicle.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating a configuration of a vehicle according to one example embodiment of the disclosure.

FIG. 2 is a table illustrating a method of detecting a mood of an occupant using a detector in the vehicle according to the example embodiment of the disclosure.

FIG. 3 is a table illustrating the method of detecting a mood of an occupant using the detector in the vehicle according to the example embodiment of the disclosure.

FIG. 4 is a table illustrating exemplary sound quality parameters to be set by a setting unit in the vehicle according to the example embodiment of the disclosure.

FIG. 5 is a flowchart of a process in the vehicle according to the example embodiment of the disclosure.

### DETAILED DESCRIPTION

A traveling sound generated in accordance with an accelerator operation performed by a driver who drives a vehicle is outputted regardless of the mood of the driver at that time. The driver feels uncomfortable with the traveling sound depending on the mood of the driver.

It is desirable to provide a vehicle and a control system each of which makes it possible to provide traveling sounds that improve a mood of an occupant in a vehicle.

### Example Embodiments

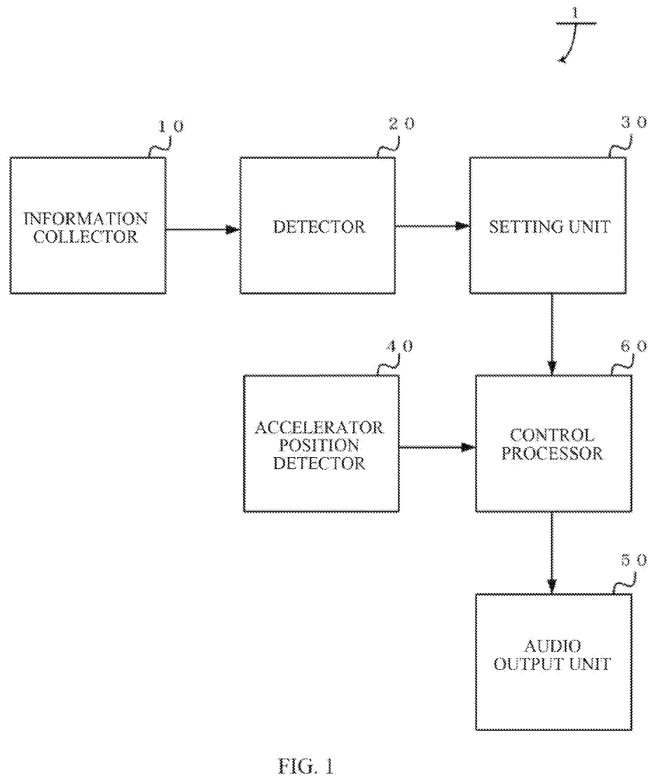

In the following, a vehicle according to an example embodiment of the disclosure is described in detail with reference to FIGS. 1 to 5.

Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Configuration of Vehicle 1

As illustrated in FIG. 1, the vehicle 1 according to an example embodiment may include an information collector 10, a detector 20, a setting unit 30, an accelerator position detector 40, an audio output unit 50, and a control processor 60.

[e] The information collector 10 collects information regarding a mood of an occupant of the vehicle 1.

In one example, as the information regarding the mood of the occupant, the information collector 10 may collect voices uttered by the occupant, captured images of the occupant, biological information of the occupant, and social media information on posts posted on social media by the occupant.

For example, the information collector 10 may be a device that collects the voices uttered by the occupant using a sensor such as a microphone disposed inside the vehicle 1.

The information collector 10 may be a device that collects images of the face, body, and other parts of the occupant captured by a sensor such as a camera disposed inside the vehicle 1, for example.

The information collector 10 may be a device that collects the biological information, such as a body heat, a heart rate, and a sweat amount, of the occupant using a communication interface that communicates with a wearable device of the occupant, for example.

The information collector 10 may be a device that collects posts or the like posted on a social media website by the occupant using a communication interface that communicates with a portable device (e.g., a smartphone or a tablet) of the occupant, for example.

The information collector 10 may send the collected information regarding the mood of the occupant to the detector 20.

The detector 20 detects a current mood of the occupant based on the information regarding the mood of the occupant.

In one example, the detector 20 may detect a current mood of the occupant based on the information on moods of the occupant received from the information collector 10, and may send the result of detection to the setting unit 30.

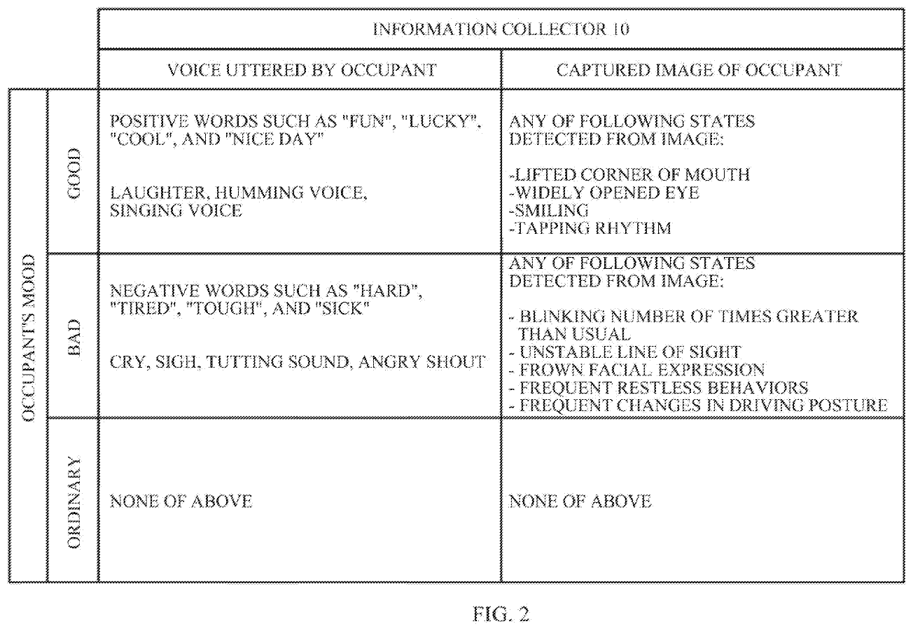

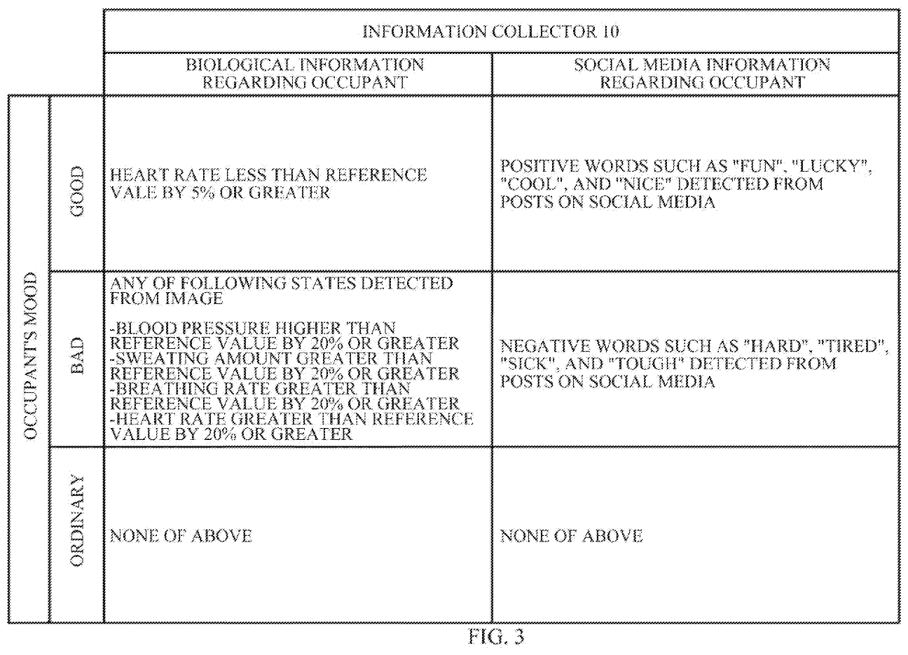

An exemplary method of detecting the current mood of the occupant using the detector 20 is described below with reference to FIGS. 2 and 3.

Based on the information regarding the mood of the occupant received from the information collector 10, the detector 20 may determine which mood of good, ordinary, and bad moods the occupant currently has.

As illustrated in FIG. 2, the detector 20 may detect words representing the mood of the occupant from the voices uttered by the occupant, and may detect the current mood of the occupant based on the detected words.

The detector 20 may further detect sounds representing the mood of the occupant, such as laughter, a cry, a whistle, a singing voice, a humming voice, a tutting sound, or a sigh, and may detect the current mood of the occupant based on the result of detection.

The detector 20 may analyze the captured image of the occupant to detect, for example, a facial expression of the occupant (e.g., the degree of lifting of a corner of the mouth), the number of times of blinking, the degree of opening of the eyes, the direction of the line of sight, a restless behavior, and a driving posture of the occupant, and may detect the current mood of the occupant based on the result of detection.

As illustrated in FIG. 3, the detector 20 may detect the current mood of the occupant based on the biological information such as a body heat, a breathing rate, a heart rate, or a blood pressure of the occupant.

The detector 20 may detect words representing the mood of the occupant from, for example, text messages posted on social media by the occupant, and may detect the current mood of the occupant based on the detected words.

The detector 20 may integrate the results of detection of the mood of the occupants based on the respective pieces of information collected by the information collector 10 with each other to determine the mood of the occupant.

In one example, the detector 20 may count the number of items determined to correspond to the good mood and the number of items determined to correspond to the bad mood in the results of determination based on the respective pieces of information received from the information collector 10 descried above. The detector 20 may determine the mood represented by the items larger in number than the other as the current mood of the occupant.

In a case where neither the item determined to correspond to the good mood nor the item determined to correspond to the bad mood is detected by the determination of the mood based on the information received from the information collector 10, the detector 20 may determine that the current mood of the occupant is the ordinary mood.

Note that the detection method described above is a mere example, and each item may be weighted upon the counting described above, for example.

For example, in a case where a negative word is detected from the voices uttered by the occupant, the detector 20 may assign a weight of 5 to the negative word rather than counting the negative word as 1 upon the counting of items.

The detection method described above is not limited to the method described above, and any detection method may be used as long as the detector 20 is able to detect the current mood of the occupant by integrating the respective pieces of information on moods of the occupant collected by the information collector 10.

The setting unit 30 may set a sound quality parameter of a traveling sound to be outputted to the interior of a vehicle compartment of the vehicle 1 based on the mood of the occupant.

The setting of a sound quality parameter of the traveling sound by the setting unit 30 may include at least setting of a tone frequency of the traveling sound, setting of a sound pressure of the traveling sound, and setting of sound followability to accelerator positions.

In one example, the setting unit 30 may set the tone frequency, the sound pressure, and the sound followability to accelerator positions based on the mood of the occupant detected by the detector 20, and may send the setting values to the control processor 60.

The setting of a tone frequency may be the setting of a tone of the traveling sound to be outputted to the interior of the vehicle compartment of the vehicle 1. In one example, such a setting value that reproduces a characteristic traveling sound of a formula car, a high-end sports car, or a high-end large-displacement car may be set in the setting of a tone frequency.

For example, the setting unit 30 may send the control processor 60 a traveling sound frequency characteristic set for each accelerator position angle to reproduce a traveling sound of a formula car.

The setting of a sound pressure may be the setting of a parameter of a sound pressure level of the traveling sound to be outputted to the interior of the vehicle compartment of the vehicle 1. In one example, the setting unit 30 may send the control processor 60 a maximum sound level of the traveling sound to be outputted to the interior of the vehicle compartment of the vehicle 1.

The setting of sound followability to accelerator positions may be the setting of a parameter of an amount of change in traveling sound upon an accelerator operation. In one example, the setting unit 30 may set the amount of change in sound pressure to be made upon a change in the accelerator position and the amount of change in frequency characteristic of the traveling sound to be made upon a change in the accelerator position.

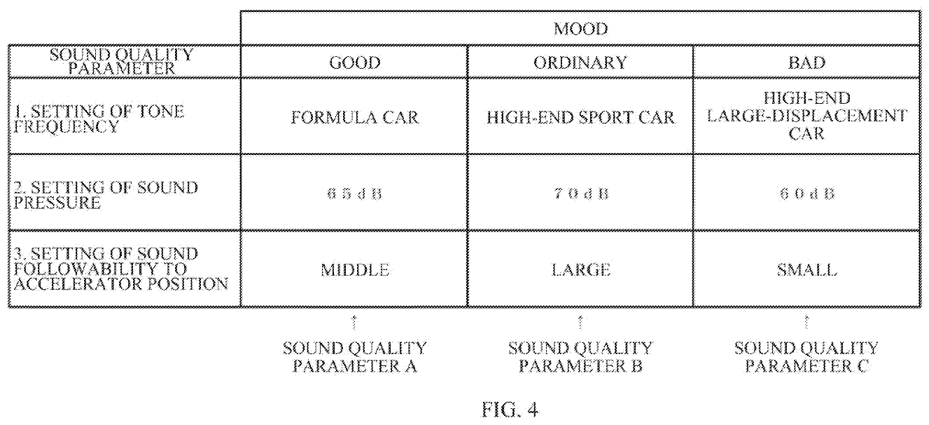

As illustrated in FIG. 4, when the detector 20 determines that the occupant is in the good mood, the setting unit 30 may set a tone frequency of a formula car, a sound pressure of 65 dB, and a mid-level sound followability to accelerator positions (i.e., a sound quality parameter A), for example.

That is, when the detector 20 determines that the occupant is in the good mood, the setting unit 30 may set an energetic and powerful traveling sound of a formula car to keep and improve the good mood of the occupant.

When the detector 20 determines that the occupant is in the ordinary mood, the setting unit 30 may set a tone frequency of a high-end sport car, a sound pressure of 70 dB, and a high-level sound followability to accelerator positions (i.e., a sound quality parameter B), for example.

That is, when the detector 20 determines that the occupant is in the ordinary mood, in order to improve the mood of the occupant to the good mood, the setting unit 30 may set a traveling sound of a high-end sport car with a sound pressure and a tone that greatly change in accordance with the accelerator positions to give the occupant a joyful driving experience.

When the detector 20 determines that the occupant in the bad mood, the setting unit 30 may set a tone frequency of a high-end large-displacement car, a sound pressure of 60 dB, and a low-level sound followability to accelerator positions (i.e., a sound quality parameter C), for example.

That is, when the detector 20 determines that the occupant is in the bad mood, the setting unit may set a traveling sound of a high-end large-displacement car with a low sound pressure that the occupant feels relaxed with, rather than the energetic traveling sound of a formula car or the like.

The accelerator position detector 40 may detect accelerator positions of the vehicle 1.

In one example, the accelerator position detector 40 may include, for example, an accelerator position sensor. The accelerator position sensor may detect a rotation angle of a throttle valve shaft when the driver who drives the vehicle 1 performs an accelerator operation, and the acceleration position detector 40 may send the result of detection to the control processor 60.

The audio output unit 50 may be, for example, a sound speaker. The audio output unit 50 may output a traveling sound generated by the control processor 60 to be described later to the interior of the vehicle compartment of the vehicle 1.

The control processor 60 may control an overall operation of the vehicle 1 in accordance with a control program stored in a non-illustrated read only memory (ROM).

In the present example embodiment, the control processor 60 may generate the traveling sound based on the sound quality parameter and the accelerator position, and may output the traveling sound to the interior of the vehicle compartment of the vehicle 1.

In one example, the control processor 60 may generate a traveling sound based on the sound quality parameter set by the setting unit 30 and the information on the accelerator position received from the accelerator position detector 40, and may send the traveling sound to the audio output unit 50.

### Process in Vehicle 1

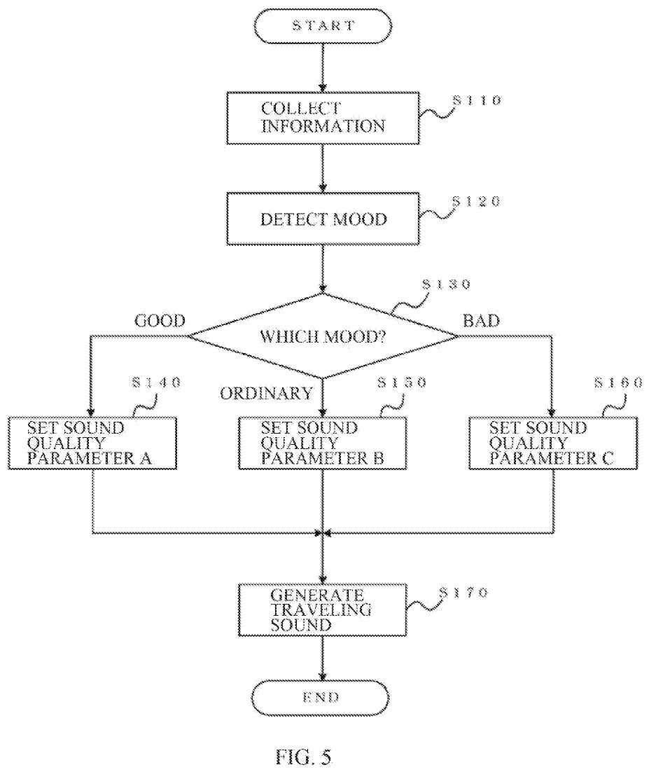

An exemplary procedure of the process in the vehicle 1 is described below with reference to FIG. 5.

The information collector 10 may acquire the information on moods of the occupant (Step S110), following which the procedure may proceed to Step S120.

The detector 20 may detect the current mood of the occupant received from the information on moods of the occupant received from the information collector 10 (Step S120), following which the procedure may proceed to Step S130.

The setting unit 30 may determine which mood of the good, ordinary, and bad moods the current mood of the occupant detected by the detector 20 corresponds to (Step S130).

If the setting unit 30 determines that the current mood of the occupant detected by the detector 20 corresponds to the good mood (Step S130: GOOD), the procedure may proceed to Step S140.

If the current mood of the occupant detected by the detector 20 corresponds to the ordinary mood (Step S130: ORDINARY), the procedure may proceed to Step S150.

If the detector 20 determines that the current mood of the occupant detected by the detector corresponds to the bad mood (Step S130: BAD), the procedure may proceed to Step S160.

When determining that the current mood of the occupant detected by the detector 20 corresponds to the good mood (Step S130: GOOD), the setting unit 30 may set the setting value of the sound quality parameter A to the control processor 60 (Step S140), following which the procedure may proceed to Step S170.

When determining that the current mood of the occupant detected by the detector 20 corresponds to the ordinary mood (Step S130: ORDINARY), the setting unit 30 may set the setting value of the sound quality parameter B to the control processor 60 (Step S150), following which the procedure may proceed to Step S170.

When determining that the current mood of the occupant detected by the detector 20 corresponds to the bad mood (Step S130: BAD), the setting unit 30 may set the setting value of the sound quality parameter C to the control processor 60 (Step S160), following which the procedure may proceed to Step S170.

The control processor 60 may generate the traveling sound based on the sound quality parameter set by the setting unit 30 and the accelerator position received from the accelerator position detector 40 (Step S170), and may output the traveling sound to the interior of the vehicle compartment of the vehicle 1. Thereafter, the procedure may end.

### Workings and Effects

As described above, the setting unit 30 of the vehicle 1 according to the above-described example embodiment sets the sound quality parameter of the traveling sound to be outputted to the interior of the vehicle compartment of the vehicle 1 based on the current mood of the occupant detected by the detector 20.

The control processor 60 generates the traveling sound based on the sound quality parameter set by the setting unit 30 and the accelerator position, and outputs the traveling sound to the interior of the vehicle compartment of the vehicle 1.

That is, the vehicle 1 detects the current mood of the occupant based on the information on moods of the occupant collected by the information collector 10, sets the sound quality parameter (e.g., the sound frequency, the sound pressure, and the sound followability to the accelerator position) matching the current mood of the occupant, and provides the traveling sound to the occupant.

It is therefore possible for the vehicle 1 to provide the traveling sound matching the current mood of the occupant, which makes it possible to improve the mood of the occupant.

When determining that the occupant is in the bad mood, the vehicle 1 may set the traveling sound with a low sound pressure to calm down the current mood of the occupant. The bad mood of the occupant is thereby improved during driving of the vehicle 1.

When determining that the occupant is in the ordinary mood, the vehicle 1 may set the energetic traveling sound that greatly changes in accordance with accelerator positions. This provides the occupant with an exhilarating and joyful driving experience to improve the current mood of the occupant.

When determining that the occupant is in the good mood, the vehicle 1 may set the energetic and powerful traveling sound. This provides the occupant with an exhilarating and joyful driving experience to maintain or improve the good mood of the occupant.

The detector 20 may detect the current mood of the occupant based on the information including the voices uttered by the occupant, the captured images of the occupant, and the biological information of the occupant that are collected by the information collector 10.

That is, the detector 20 may detect the current mood of the occupant based on the content of utterances of the occupant, the facial expressions of the occupant, and the biological information of the occupant on which the mood of the occupant is prominently reflected.

The vehicle 1 is thus able to detect the current mood of the occupant with high accuracy and provide the traveling sound matching the current mood of the occupant.

The detector 20 may detect the current mood of the occupant based on the social media information on the occupant's posts collected by the information collector 10.

That is, the detector 20 may detect the current mood of the occupant based on the social media information that explicitly describing the moods of the occupant.

Accordingly, the vehicle 1 is able to detect the current mood of the occupant with high accuracy and provide the traveling sound matching the current mood of the occupant.

### Modification Example 1

A control system including the vehicle 1 and a server communicable with the vehicle 1 may be provided, and the process to be performed by the detector 20 described above may be performed in the server.

The server may be coupled to the vehicle 1 via the internet to mutually communicate with each other.

The server may include circuitry that detects the current mood of the occupant based on the information on moods of the occupant received from the information collector 10. The server may further include a transmitter provided with a communication interface that receives the information on moods of the occupants in the vehicle 1 from the vehicle 1 and sends the result of detection at the circuitry (i.e., a detection result) to the setting unit 30 of the vehicle 1.

Based on the information acquired from the server as a response to the information sent to the server (i.e., the result of detection of the current mood of the occupant detected in the server), the setting unit 30 may set a sound quality parameter of a traveling sound.

The control system is thus able to provide the occupant with the traveling sound matching the current mood of the occupant, which makes it possible to improve the mood of the occupant.

Further, the server may be coupled to multiple vehicles to receive the information on moods of occupants from the respective vehicles. The server may detect the current moods of the occupants based on the received information, and may then send the results of detection to the respective vehicles.

That is, the server may detect the current moods of the occupants based on the information on moods of the occupants received from the respective vehicles, and may send the results of the detection to the respective vehicles.

This eliminates the need for providing each of the vehicles with the detector 20 that detects the mood of the occupant, reducing costs of the vehicle.

Further, the server may secure sufficient resources enough to detect the mood of the occupant, which enables a more detailed detection of the mood of the occupant.

The server is thus able to detect the mood of the occupant with higher accuracy.

### Modification Example 2

The vehicle 1 described above detects the mood of the occupant at the start of driving after boarding of the occupant on the vehicle 1, and determines the sound quality parameter of the traveling sound based on the detected mood. However, when a change in the mood of the occupant is detected during traveling of the vehicle 1, the vehicle 1 may reset the sound quality parameter currently set to another sound quality parameter matching the mood of the occupant after the change in the mood.

For example, when detecting a change in the mood of the occupant from the bad mood to the ordinary mood, the detector 20 may send data indicating that the current mood of the occupant is the ordinary mood may be sent to the setting unit 30. The setting unit 30 may then change the sound quality parameter currently set to the sound quality parameter corresponding to the ordinary mood.

That is, the vehicle 1 may continuously detect the mood of the occupant during traveling of the vehicle 1, and may change the traveling sound in accordance with the change in the mood of the occupant. The vehicle 1 is thus able to always provide the traveling sound matching the mood of the occupant during traveling the vehicle 1.

Because the vehicle 1 is able to always provide the traveling sound matching the mood of the occupant, it is possible for the vehicle 1 to further improve the mood of the occupant.

### Modification Example 3

The sound quality parameter to be set by the setting unit 30 of the vehicle 1 described above may be changed depending on preferences of the occupant.

For example, when the occupant prefers a slightly lower, more powerful traveling sound or a sound with a higher sound pressure to the traveling sound of a high-end sport car currently outputted to the interior of the vehicle compartment of the vehicle 1, the preference of the occupant may be reflected on the sound quality parameter to be set by the setting unit 30.

The vehicle 1 is thus able to provide the traveling sound matching the preference of the occupant, which makes it possible to further improve the mood of the occupant.

Note that it is possible to implement the vehicle 1 of the example embodiments of the disclosure by recording the processes to be executed by, for example, the detector 20, the setting unit 30, and the control processor 60 on a non-transitory recording medium readable by a computer system, and causing, for example, the detector 20, the setting unit 30, and the control processor 60 to load the programs recorded on the non-transitory recording medium thereon to execute the programs. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

One or more of the detector 20, the setting unit 30, and the control processor 60 in FIG. 1 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the detector 20, the setting unit 30, and the control processor 60. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the detector 20, the setting unit and the control processor 60 in FIG. 1.

1. A vehicle comprising:
an information collector configured to collect information regarding an occupant of the vehicle to be used for determining a mood of the occupant;
a detector configured to detect the mood of the occupant based on the information;
a setting unit configured to perform setting of one or more sound quality parameters of a traveling sound to be outputted to an interior of a vehicle compartment of the vehicle based on the mood of the occupant;
an accelerator position detector configured to detect an accelerator position of the vehicle; and
a control processor configured to generate the traveling sound based on the one or more sound quality parameters and the accelerator position and output the traveling sound to the interior of the vehicle compartment of the vehicle.

2. The vehicle according to claim 1, wherein the information comprises voice uttered by the occupant, a captured image of the occupant, and biological information of the occupant.

3. The vehicle according to claim 2, wherein the information further comprises social media information on posts posted on social media by the occupant.

4. The vehicle according to claim 2, wherein the one or more sound quality parameters comprise a tone frequency of the traveling sound, a sound pressure of the traveling sound, and followability of the traveling sound to the accelerator position.

5. The vehicle according to claim 3, wherein the one or more sound quality parameters comprise a tone frequency of the traveling sound, a sound pressure of the traveling sound, and followability of the traveling sound to the accelerator position.

6. A control system comprising:
a vehicle; and
a server communicably coupled to the vehicle, wherein
the vehicle comprises
an information collector configured to collect information regarding an occupant of the vehicle to be used for determining a mood of the occupant and send the information to the server,
a setting unit configured to perform setting of one or more sound quality parameters of a traveling sound to be outputted to an interior of a vehicle compartment of the vehicle based on a mood of the occupant detected by the server,
an accelerator position detector configured to detect an accelerator position of the vehicle, and
a control processor configured to generate the traveling sound based on the one or more sound quality parameters and the accelerator position and output the traveling sound to the interior of the vehicle compartment of the vehicle, and
the server comprises
a detector configured to perform a determination as to the mood of the occupant of the vehicle based on the information received from the vehicle, and
a transmitter configured to send a result of the determination to the vehicle.

7. A vehicle comprising:
a sensor or a communication interface configured to collect information to be used for determining a mood of an occupant of the vehicle;
an accelerator position sensor configured to detect an accelerator position of the vehicle;
a sound speaker configured to output a traveling sound to an interior of a vehicle compartment of the vehicle; and
circuitry configured to process the first information collected by the sensor or the communication interface and data on the accelerator position detected by the accelerator position sensor, wherein
the circuitry is further configured to
detect the mood of the occupant based on the first information collected by the sensor or the communication interface,
set one or more sound quality parameters of the traveling sound to be outputted to the interior of the vehicle compartment of the vehicle based on the mood of the occupant,
generate the traveling sound based on the one or more sound quality parameters and the accelerator position, and
output the traveling sound to the sound speaker.

8. A control system comprising:
a vehicle; and
a server communicably coupled to the vehicle, wherein
the vehicle comprises
a sensor or a first communication interface configured to collect first information regarding to be used for determining a mood of an occupant of the vehicle,
a second communication interface configured to send the first information collected by the sensor or the first communication interface to the server,
an accelerator position sensor configured to detect an accelerator position of the vehicle,
a sound speaker configured to output a traveling sound to an interior of a vehicle compartment of the vehicle, and
first circuitry configured to process second information acquired from the server as a response to the first information sent from the second communication interface to the server and data on the accelerator position detected by the accelerator position sensor, the first circuitry being further configured to
set one or more sound quality parameters of the traveling sound to be outputted to the interior of the vehicle compartment of the vehicle based on the second information acquired from the server,
generate the traveling sound based on the one or more sound quality parameters and the accelerator position, and
output the traveling sound to the sound speaker, and
the server comprises
second circuitry configured to perform a determination as to the mood of the occupant of the vehicle based on the first information received from the vehicle, and
a third communication interface configured to receive the first information from the vehicle and send a result of the determination as the second information to the vehicle.
